(19) United States
(12) Patent Application Publication
(10) Pub. No.: US 2026/0184943 A1
(43) Pub. Date: Jul. 2, 2026

(54) THREE-DIMENSIONAL PRINTING ENERGY ABSORBING COMPOSITION

(71) Applicant: PERIDOT PRINT LLC, Palo Alto, CA (US)

(72) Inventors: Emre Hiro Discekici, San Diego, CA (US); Jake H. Thomas, San Diego, CA (US); Emily Levin, San Diego, CA (US); Dennis J. Schissler, San Diego, CA (US)

(21) Appl. No.: 19/123,181

(22) PCT Filed: Oct. 24, 2022
(86) PCT No.: PCT/US2022/047565

§ 371 Date: Apr. 22, 2025

(51) Int. Cl. C09D 7/63; B29C 64/165; B29K 77/00; B29K 507/04; B29L 31/00; B33Y 10/00; B33Y 40/00; B33Y 70/10; B33Y 80/00; C08K 3/04; C08K 5/13; C08K 5/25; C09D 7/45; C09D 7/48; C09D 7/61

(52) U.S. Cl. CPC C09D 7/63; B29C 64/165; B33Y 10/00; B33Y 40/00; B33Y 70/10; B33Y 80/00; C09D 7/45; C09D 7/48; C09D 7/61; B29K 2077/00; B29K 2507/04; B29L 2031/772; C08K 3/04; C08K 5/13; C08K 5/25

(57) ABSTRACT

An example of a three-dimensional (3D) printing energy absorbing composition includes carbon black particles present in an amount ranging from about 0.01 wt % active to about 3 wt % active, based on a total weight of the 3D printing energy absorbing composition; benzyl alcohol present in an amount ranging from about 1 wt % active to about 40 wt % active, based on the total weight of the 3D printing energy absorbing composition; a solvent for benzyl alcohol having a boiling point of 150 C or higher present in an amount ranging from about 20 wt % active to about 60 wt % active, based on the total weight of the 3D printing energy absorbing composition; and a balance of water.

### BACKGROUND

Three-dimensional (3D) printing can be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light or infrared light. 3D printing techniques may be used to generate 3D printed parts with various properties.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example 3D printing method which utilizes the 3D printing energy absorbing composition, in accordance with the present disclosure;

FIG. 2 is a schematic illustration of an example 3D printing method which utilizes the 3D printing energy absorbing composition, in accordance with the present disclosure;

FIG. 3 is a graphical representation of the % strain at break, the tensile strength (MPa), and the Young's Modulus (MPa) of an example 3D object formed with an example of an energy absorbing composition disclosed herein and of a comparative example 3D object; and

FIG. 4 is a photograph, reproduced in black and white, of an example of a 3D object formed with an example of an energy absorbing composition disclosed herein.

### DETAILED DESCRIPTION

Some three-dimensional (3D) printing methods utilize an energy absorbing substance (e.g., an energy absorber) to pattern a build material composition. In these methods, an entire layer of the build material composition is exposed to radiation, but the patterned region of the build material composition is coalesced/fused and becomes a layer of a 3D printed object. In the patterned region, the energy absorbing substance is capable of at least partially penetrating into voids between the particles of the build material composition, and is also capable of spreading onto an exterior surface of build material particles. The energy absorbing substance is also capable of converting absorbed radiation energy into thermal energy, which coalesces/fuses build material particles that have been patterned with the energy absorbing substance. Fusing/coalescing causes the build material particles to join/blend to form a single entity (i.e., the layer of the 3D part). Fusing/coalescing may involve at least partial thermal merging, melting, binding, and/or some other mechanism that causes the build material composition to form the layer of the 3D object.

Some 3D printing methods/techniques that utilize an energy absorbing substance result in strongly colored 3D objects or 3D object layers, depending on the energy absorber and the other components that are used in the method. Some of these methods utilize darkly colored energy absorbers (e.g., black) because such absorbers achieve desirable build material coalescence and impart desirable mechanical properties to the 3D object. However, the dark color may be undesirable for some 3D printed objects.

Disclosed herein is a three-dimensional printing energy absorbing composition that contains carbon black particles as the energy absorber. This energy absorbing composition can be used to produce mechanically strong 3D objects or 3D object layers (e.g., in terms of object strength and flexibility) that exhibit a color of a build material composition used to form the object or object layers as opposed to the color of the carbon black itself. As such, the resulting 3D object may be a color other than black; e.g., white or off-white.

The terms “three-dimensional printing energy absorbing composition,” “3D printing energy absorbing composition,” and “energy absorbing composition” are used interchangeably herein.

Throughout this disclosure, a weight percentage that is referred to as “wt % active” refers to the loading of an active component of a stock formulation that is present, e.g., in the 3D printing energy absorbing composition, etc. For example, the carbon black particles may be present in a water-based formulation (e.g., a stock solution or dispersion) before being incorporated into the 3D printing energy absorbing composition. In this example, the wt % active of the carbon black particles accounts for the loading (as a weight percent) of the carbon black solids that are present in the energy absorbing composition, and does not account for the weight of the other components (e.g., water, etc.) that are present in the stock solution or dispersion with the carbon black. The term “wt %,” without the term actives, refers to the loading (in the energy absorbing composition) of a 100% active component that does not include other non-active components therein.

3D Printing Energy Absorbing Composition

Described herein are examples of a three-dimensional (3D) printing energy absorbing composition, comprising: carbon black particles present in an amount ranging from about 0.01 wt % active to about 3 wt % active, based on a total weight of the 3D printing energy absorbing composition; benzyl alcohol present in an amount ranging from about 1 wt % active to about 40 wt % active, based on the total weight of the 3D printing energy absorbing composition; a solvent for benzyl alcohol having a boiling point of 150° C. or higher present in an amount ranging from about 20 wt % active to about 60 wt % active, based on the total weight of the 3D printing energy absorbing composition; and a balance of water.

### Electromagnetic Radiation Absorber

Examples of the 3D printing energy absorbing composition include carbon black particles as the electromagnetic radiation absorber. The carbon black particles are used in a very small amount (less than 3 wt % active) and the solvent system set forth herein is able to readily disperse the low loading of the carbon black particles. The resulting energy absorbing composition is able to generate white, off-white, or another light colored 3D printed article without deleteriously affecting the mechanical properties of the 3D printed article.

Carbon black has substantial absorption in the visible region (400 nm-780 nm) and in the near infrared region (e.g., 800 nm to 2500 nm). Even at the low loadings set forth herein, this absorption generates heat suitable for coalescing/fusing during 3D printing, which leads to 3D objects (or 3D object regions/layers) having mechanical integrity and relatively uniform mechanical properties (e.g., strength, elongation at break, etc.).

As used herein “substantial absorption” means that at least 80% of radiation having wavelengths within the specified range is absorbed by the substance being referred to (e.g., carbon black particles, etc.).

In the examples set forth herein, the carbon black particles are present in a dispersion before being incorporated into the energy absorbing composition. In an example, the carbon black particles are present in the dispersion in an amount ranging from about 0.5 wt % to about 50 wt %, based on a total weight of the dispersion. In another example, the carbon black particles are present in the dispersion in an amount ranging from about 10 wt % to about 50 wt %, based on a total weight of the dispersion.

The carbon black particles (prior to being incorporated into the energy absorbing composition) may be dispersed in water alone or in combination with an additional water-soluble or water-miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, propylene glycol, dipropylene glycol, diethylene glycol butyl ether, other glycol ethers or a combination thereof. It is to be understood however, that the liquid components of the dispersion become part of the 3D printing energy absorbing composition.

The dispersion may then be incorporated with the other components to form the energy absorbing composition so that the amount of the carbon black particles that is present in the energy absorbing composition ranges from about 0.01 wt % active to about 3 wt % active, based on the total weight of the 3D printing energy absorbing composition. In one example, the carbon black particles are present in an amount ranging from about 0.1 wt % active to about 1 wt % active, based on the total weight of the 3D printing energy absorbing composition. In other examples, the carbon black particles are present in an amount ranging from about 0.2 wt % active to about 0.8 wt % active, or from about 0.3 wt % active to about 0.7 wt % active, or from about 0.4 wt % active to about 0.6 wt % active, based on the total weight of the 3D printing energy absorbing composition.

As described herein, the relatively low carbon black particle loadings used in the energy absorbing composition contribute to the jettability of the composition, and enable the 3D printed objects/layers to exhibit a color of or similar to a build material used to form the 3D objects/layers. The relatively low carbon black particle loadings have also surprisingly been found to absorb a sufficient amount of energy for fusing/coalescing the build material composition. Additionally, the relatively low carbon black particle loadings lead to unexpectedly improved mechanical properties.

### Benzyl Alcohol

The 3D printing energy absorbing composition further includes benzyl alcohol. Benzyl alcohol is an aromatic alcohol with the formula C₆H₅CH₂OH. The benzyl alcohol, when used in combination with the carbon black particles (and the solvent for benzyl alcohol) in the energy absorbing composition, can be used to generate 3D objects/object layers with strong mechanical properties. As explained previously, the energy absorbing composition may also be used to generate 3D object(s)/object layer(s) that exhibit a color of the build material used to form the object(s)/object layer(s).

In an example, the benzyl alcohol is present in the 3D printing energy absorbing composition in an amount ranging from about 1 wt % active to about 40 wt % active, based on the total weight of the 3D printing energy absorbing composition. In other examples, the benzyl alcohol is present in an amount ranging from about 5 wt % active to about 35 wt % active, or from about 10 wt % active to about 30 wt % active, based on the total weight of the 3D printing energy absorbing composition. In one example, the benzyl alcohol is present in the energy absorbing composition in an amount of about 14 wt % active. The benzyl alcohol may be dissolved in a suitable solvent (e.g., having a boiling point of 150° C. or higher).

### Solvent for Benzyl Alcohol

The 3D printing energy absorbing composition further includes a solvent for benzyl alcohol having a boiling point of 150° C. or higher.

The solvent for benzyl alcohol that is selected may have a higher solubility for benzyl alcohol than water. The inclusion of such a solvent enables the 3D printing energy absorbing composition to be prepared with a predetermined amount of benzyl alcohol that is desirable for solubilizing a build material during 3D printing. The amount of solvent for benzyl alcohol that is included may depend, in part, upon the amount of benzyl alcohol that is included in the 3D printing energy absorbing composition. In an example, the benzyl alcohol and the solvent are present (in the 3D printing energy absorbing composition) in a weight ratio ranging from about 1:6 to about 2:3. In an example, the benzyl alcohol and the solvent are present (in the 3D printing energy absorbing composition) in a weight ratio of 1:3.

A wide variety of solvents for benzyl alcohol (having a boiling point of 150° C. or higher) may be used. In some examples, the solvent for benzyl alcohol is selected from the group consisting of polyethylene glycol having a weight average molecular weight ranging from about 190 Daltons to about 420 Daltons, 1-(2-hydroxyethyl)-2-pyrrolidone, glycerol, propylene glycol, and combinations thereof. Some of these solvents, such as propylene glycol (bp˜188° C.) and 1-(2-hydroxyethyl)-2-pyrrolidone (bp˜175° C.), have a boiling point higher than 170° C. Other of these solvents, such as propylene glycol 300 (bp>220° C.), propylene glycol 400 (bp˜290° C.), and glycerol (290° C.) have a boiling point higher than 200° C.

The solvent for benzyl alcohol may be included in the 3D printing energy absorbing composition with one or more additional water soluble or water miscible organic co-solvents. Classes of water soluble or water miscible organic co-solvents that may be used in the 3D printing energy absorbing composition include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,2-propanediol, 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, 1-methyl-2-pyrrolidone, and the like. Other examples of organic co-solvents include dimethyl sulfoxide (DMSO), isopropyl alcohol, ethanol, pentanol, acetone, or the like.

Whether the energy absorbing composition includes the solvent for benzyl alcohol alone or in combination with another co-solvent, the solvent(s) may be present in the 3D printing energy absorbing composition in a total amount ranging from about 20 wt % active to about 60 wt % active, based on the total weight of the 3D printing energy absorbing composition. In an example, the solvent(s) is present in the 3D printing energy absorbing composition in an amount ranging from about 20 wt % active to about 40 wt % active, or from about 30 wt % active to about 50 wt % active, or from about 35 wt % active to about 45 wt % active, based on the total weight of the 3D printing energy absorbing composition.

### Stabilizer

The 3D printing energy absorbing composition may further include a stabilizer. The stabilizer aids in extending the shelf life of the 3D printing energy absorbing composition and in maintaining the printability of the composition. The stabilizer may be an antioxidant. As used herein, the term “antioxidant” refers to a substance which prevents or inhibits oxidation of a material through scavenging of radical species. In an example, the 3D printing energy absorbing composition further includes a hydrazide antioxidant selected from the group consisting of adipic acid dihydrazide, oxalyl dihydrazide, succinic dihydrazide, azelaic dihydrazide, sebacic dihydrazide, dodecanedioic dihydrazide, and a combination thereof. In one specific example, the hydrazide antioxidant is adipic acid dihydrazide.

It is desirable that the stabilizer be dissolved in the solvent(s) of the energy absorbing composition. For examples of the stabilizer that are minimally or not soluble in the solvent(s) of the energy absorbing composition, it is to be understood that a solvent for the stabilizer may be added to the energy absorbing composition. In an example, the solvent for the stabilizer is a carbon-chain diol solvent having from 2 carbon atoms to 6 carbon atoms (e.g., ethylene glycol, propanediol, 1,4-butanediol, 1,5-pentanediol, 1,2-hexanediol, etc.). The stabilizer may be dissolved in the solvent, and then the stabilizer solution may be added to the solvent(s) of the energy absorbing composition to incorporate the stabilizer in any of the amounts set forth herein.

In some examples, the hydrazide antioxidant is present in the 3D printing energy absorbing composition in an amount ranging from about 0.01 wt % active to about 1 wt % active, based on the total weight of the 3D printing energy absorbing composition. In other examples, the hydrazide antioxidant is present in an amount ranging from about 0.05 wt % active to about 0.9 wt % active, or from about 0.1 wt % active to about 0.8 wt % active, or from about 0.2 wt % active to about 0.8 wt % active, or from about 0.3 wt % active to about 0.7 wt % active, or from about 0.4 wt % active to about 0.6 wt % active, based on the total weight of the 3D printing energy absorbing composition.

Some examples of the 3D printing energy absorbing composition consist of the carbon black particles (and any components of the carbon black dispersion), the benzyl alcohol, the solvent for benzyl alcohol, and the water, with no other components. Other examples of the 3D printing energy absorbing composition consist of the carbon black particles (and any components of the carbon black dispersion), the benzyl alcohol, the solvent for benzyl alcohol, the stabilizer, and the water, with no other components. In still other examples, the 3D printing energy absorbing composition further includes an additive.

### Additive(s)

The 3D printing energy absorbing composition may further include an additive selected from the group consisting of a humectant, a surfactant, an antimicrobial agent, a chelating agent, an anti-kogation agent, a pH adjuster, and combinations thereof. In one example, the 3D printing energy absorbing composition consists of the carbon black particles (and any components of its dispersion), the benzyl alcohol, the solvent for benzyl alcohol (which may include additional (an) co-solvent(s)), the stabilizer, the additive(s), and the water.

The energy absorbing composition may include a humectant. An example of a suitable humectant is ethoxylated glycerin having the following formula:

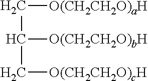

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the energy absorbing composition ranges from about 3 wt % active to about 10 wt % active, based on the total weight of the energy absorbing composition.

The 3D printing energy absorbing composition may further include the surfactant. Suitable surfactant(s) for the 3D printing energy absorbing composition include non-ionic or anionic surfactants. It may be desirable to select a surfactant that does not react with the benzyl alcohol. Some example surfactants include alkyl polyethylene oxides, alkyl phenyl polyethylene oxides, polyethylene oxide block copolymers, acetylenic polyethylene oxides, polyethylene oxide (di) esters, polyethylene oxide amines, dimethicone copolyols, substituted amine oxides, fluorosurfactants, and the like. Some specific examples include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another suitable (anionic) surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used or a combination of surfactants are used, the total amount of surfactant(s) in the 3D printing energy absorbing composition may range from about 0.01 wt % active to about 1 wt % active, based on the total weight of the 3D printing energy absorbing composition. In another example, the total amount of surfactant(s) in the 3D printing energy absorbing composition may range from about 0.05 wt % active to about 0.9 wt % active, or from about 0.1 wt % active to about 0.8 wt % active, or from about 0.25 wt % active to about 0.75 wt % active, or from about 0.3 wt % active to about 0.7 wt % active, or from about 0.4 wt % active to about 0.6 wt % active, based on the total weight of the 3D printing energy absorbing composition.

The 3D printing energy absorbing composition may also include one or more antimicrobial agents. Antimicrobial agents are also known as biocides and/or fungicides. Examples of suitable antimicrobial agents include the NUOSEPT® (Ashland Inc.), UCARCIDE™ or KORDEK™ or ROCIMA™ (The Dow Chemical Company), PROXEL® (Arch Chemicals) series, ACTICIDER B20 and ACTICIDER M20 and ACTICIDER MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the total amount of antimicrobial agent(s) in the 3D printing energy absorbing composition ranges from about 0.01 wt % active to about 0.1 wt % active (based on the total weight of the 3D printing energy absorbing composition).

Chelating agents (or sequestering agents) may be included in the 3D printing energy absorbing composition to eliminate and/or mitigate any deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra (methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra (methylene phosphonic acid), potassium salt is commercially available as DEQUEST® 2054 from Italmatch Chemicals.

Whether a single chelating agent is used or a combination of chelating agents is used, the total amount of chelating agent(s) in the 3D printing energy absorbing composition may range from greater than 0 wt % active to about 0.5 wt % active, based on the total weight of the 3D printing energy absorbing composition.

The 3D printing energy absorbing composition may also include anti-kogation agent(s) that is/are to be jetted using thermal inkjet printing. Kogation refers to the deposit of dried printing liquid (e.g., 3D printing energy absorbing composition) on a heating element of a thermal inkjet printhead. Anti-kogation agent(s) is/are included to assist in preventing the buildup of kogation.

Examples of suitable anti-kogation agents include oleth-3-phosphate (commercially available as CRODAFOS™ 03A or CRODAFOS™ N-3A) or dextran 500 k. Other suitable examples of the anti-kogation agents include CRODAFOS™ HCE (phosphate-ester from Croda Int.), CRODAFOS® 010A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent may be present in the 3D printing energy absorbing composition in an amount ranging from about 0.1 wt % active to about 1.5 wt % active, based on the total weight of the 3D printing energy absorbing composition.

The 3D printing energy absorbing composition may also include pH adjuster(s). The type and amount of pH adjuster that is added may depend upon the initial pH of the 3D printing energy absorbing composition and the desired final pH of the composition. If the initial pH is too high (e.g., above 12), an acid may be added to lower the pH, and if the initial pH is too low (below 7.5), a base may be added to increase the pH. Examples of suitable pH adjusters include metal hydroxide bases, such as potassium hydroxide (KOH), sodium hydroxide (NaOH), etc. In an example, the metal hydroxide base may be added to the 3D printing energy absorbing composition in an aqueous solution. In another example, the metal hydroxide base may be added to the 3D printing energy absorbing composition in an aqueous solution including 5 wt % of the metal hydroxide base (e.g., a 5 wt % potassium hydroxide aqueous solution). Examples of suitable acidic pH adjusters that may be used include methane sulfonic acid, nitric acid, and phosphoric acid.

In an example, the total amount of pH adjuster(s) in the 3D printing energy absorbing composition ranges from greater than 0 wt % active to about 0.1 wt % active (based on the total weight of the 3D printing energy absorbing composition).

### Water

The balance of the 3D printing energy absorbing composition further includes water. The water may be deionized water or purified water. The amount of the water may vary depending upon the other components in the 3D printing energy absorbing composition. In an example, the water is present in an amount greater than about 20 wt %, or greater than about 30 wt %, or greater than about 40 wt %, or greater than about 50 wt %, or greater than about 75 wt %, or greater than about 90 wt %.

### Detailing Agent

Some examples of the 3D printing methods described herein utilize a detailing agent. The detailing agent may include a surfactant, a co-solvent, and a balance of water. In an example, the detailing agent consists of these components and no other components. In another example, the detailing agent further includes additional components, such as anti-kogation agent(s), antimicrobial agent(s), and/or chelating agent(s), each of which is described above in reference to the 3D printing energy absorbing composition.

The surfactant(s) that may be used in the detailing agent include any of the surfactants listed herein in reference to the 3D printing energy absorbing composition. The total amount of surfactant(s) in the detailing agent may range from about 0.10 wt % active, to about 5 wt % active, with respect to a total weight of the detailing agent.

The co-solvent(s) that may be used in the detailing agent include any of the co-solvents listed above in reference to the 3D printing energy absorbing composition. The total amount of the co-solvent(s) present in the detailing agent may range from about 1 wt % active to about 65 wt % active, based on a total weight of the detailing agent.

The examples of the detailing agent disclosed herein do not include a colorant. As such, the detailing agent may be colorless. As used herein, “colorless” means that the detailing agent is achromatic and does not include a colorant.

The balance of the detailing agent is water. As such, the amount of water may vary depending upon the amounts of the other components that are included.

### Coloring Agent

Some examples of the 3D printing methods described herein utilize a coloring agent. The coloring agent may include a colorant, a co-solvent, and a balance of water. In some examples, the coloring agent consists of these components, and no other components.

In some examples, the coloring agent may further include additional components that aid in colorant dispersability and/or ink jettability. Some examples of additional coloring agent components include dispersant(s), such as a water-soluble acrylic acid polymer (e.g., CARBOSPERSER K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins).

The coloring agent may further include a binder. The binder may be an acrylic latex binder, which may be a copolymer of any two or more of styrene, acrylic acid, methacrylic acid, methyl methacrylate, ethyl methacrylate, and butyl methacrylate.

In still other examples, the coloring agent may further include additional components, such as surfactant(s), anti-kogation agent(s), antimicrobial agent(s), chelating agent(s), and/or a buffer (each of which is described herein in reference to the 3D printing energy absorbing composition).

The colorant may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color.

In some instances, the colorant of the coloring agent may be transparent to infrared wavelengths. As used herein, “transparent” or “transparency” means that 25% or less of radiation having wavelengths within the specified range is absorbed. In other instances, the colorant of the coloring agent may not be completely transparent to infrared wavelengths, but does not absorb enough radiation to sufficiently heat the polymeric build material composition in contact therewith. In an example, the colorant absorbs less than 10% of radiation having wavelengths in a range from 650 nm to 2500 nm. In another example, the colorant absorbs less than 20% of radiation having wavelengths in a range from 650 nm to 2500 nm.

The colorant of the coloring agent is also capable of absorbing radiation with wavelengths of 650 nm or less. As such, the colorant absorbs at least some wavelengths within the visible spectrum, but absorbs little or no wavelengths within the near-infrared spectrum. This is in contrast to the carbon black particles, which absorbs wavelength within the near-infrared spectrum. As such, the colorant in the coloring agent will not substantially absorb the fusing radiation, and thus will not initiate coalescing/fusing of a build material composition in contact therewith when the build material composition is exposed to energy.

Examples of IR transparent colorants include acid yellow 23 (AY 23), AY17, acid red 52 (AR 52), AR 289, and reactive red 180 (RR 180). Examples of colorants that absorb some visible wavelengths and some IR wavelengths include cyan colorants, such as direct blue 199 (DB 199) and pigment blue 15:3 (PB 15:3).

An example of the coloring agent may include from about 1 wt % to about 10 wt % of colorant(s), from about 10 wt % to about 30 wt % of co-solvent(s), up to about 10 wt % of dispersant(s), from about 0.1 wt % to about 5 wt % of binder(s), from 0.01 wt % to about 1 wt % of anti-kogation agent(s), from about 0.05 wt % to about 0.1 wt % antimicrobial agent(s), and a balance of water.

Some examples of the coloring agent include a set of cyan, magenta, and yellow agents, such as C1893A (cyan), C1984A (magenta), and C1985A (yellow); or C4801A (cyan), C4802A (magenta), and C4803A (yellow); all of which are available from HP Inc. Other commercially available coloring agents include C9384A (printhead HP 72), C9383A (printhead HP 72), C4901A (printhead HP 940), and C4900A (printhead HP 940).

### Build Material Composition(s)

The 3D printing energy absorbing composition described herein may be suitable for printing on a polymeric build material composition. Some examples of suitable polymeric materials for the polymeric build material composition include polyamides, polyacetals, polyolefins, styrene polymers and copolymers (e.g., polystyrene), fluoropolymers, acrylic polymers and copolymers, polyethers, polyaryletherketones, polyesters (e.g., a thermoplastic copolyester (TPC)), polycarbonates (PC), a thermoplastic polyurethane (TPU), a thermoplastic polyolefin elastomer (TPO), a thermoplastic vulcanizate (TPV), a polyether block amide (PEBA), or a combination thereof. In an example, the polymer material is selected from the group consisting of polyethylene, polyethylene terephthalate (PET), polystyrene (PS), polypropylene, high density polyethylene (HDPE), polyoxymethylene (POM), polyether ketone (PEK), polyether ether ketone (PEEK), polyetherketoneketone (PEKK), polyphenylene sulfide (PPS), polytetrafluoroethylene (PTFE), polyvinylidene fluoride (PVDF), acrylonitrile styrene acrylate (ASA), poly(methyl methacrylate) (PMMA), styrene acrylonitrile (SAN), styrene maleic anhydride (SMA), poly(vinyl chloride) (PVC), polyethylenimine (PEI), and combinations thereof.

In some examples, the polymeric build material composition is a polyamide build material composition including polyamide particles. Examples of suitable polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc.), a thermoplastic polyamide (TPA), and combinations thereof.

Any of the polymeric materials in the build material composition may be in the form of a powder or a powder-like material. The powder-like material includes, for example, short fibers having a length that is greater than its width. In some examples, the powder or powder-like material may be formed from, or may include, short fibers that may, for example, have been cut into short lengths from long strands or threads of material.

The polymeric material may be made up of similarly sized particles and/or differently sized particles. In an example, the average particle size of the polymeric material ranges from about 2 μm to about 225 μm. In another example, the average particle size of the polymeric material ranges from about 10 μm to about 130 μm. The term “average particle size,” as used herein, refers to a volume-weighted mean diameter of a particle distribution.

When the build material composition includes crystalline or semi-crystalline polymeric material, the build material composition may have a wide processing window of greater than 5° C., which can be defined by the temperature range between the melting point and the re-crystallization temperature. In an example, the polymeric material in the build material composition may have a melting point ranging from about 50° C. to about 300° C. As other examples, the polymeric material in the build material composition may have a melting point ranging from about 155° C. to about 225° C., from about 155° C. to about 215° C., about 160° C. to about 200° C., from about 170° C. to about 190° C., or from about 182° C. to about 189° C. As still another example, the polymeric material in the build material composition may have a melting point of about 180° C.

When the build material composition includes thermoplastic polymeric material, the build material composition may have a melting range within the range of from about 130° C. to about 250° C.

In some examples, the build material composition does not substantially absorb radiation having a wavelength within the range from 300 nm to 1400 nm. The phrase “does not substantially absorb” means that the absorptivity of the build material composition at a particular wavelength is 25% or less (e.g., 20%, 10%, 5%, etc.).

In some examples, in addition to the polymeric material, the build material composition may include an antioxidant, a whitener, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polymeric material and/or to prevent or slow discoloration (e.g., yellowing) by preventing or slowing oxidation of the polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis (3,5-bis (1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material. In an example, the antioxidant may be included in the build material composition in an amount ranging from about 0.01 wt % to about 5 wt %, based on a total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to bring the L* of the build material composition closer to 100 (white) and/or improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). In an example, any of the aforementioned whiteners may be included in the build material composition in an amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based on the total weight of the build material composition.

Flow aid(s) may be added to improve the coating flowability of the build material composition. Flow aids may be particularly beneficial when the polymeric material in the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al2O3), tricalcium phosphate (E341), powdered cellulose (E460 (ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based on the total weight of the build material composition.

### Printing Methods

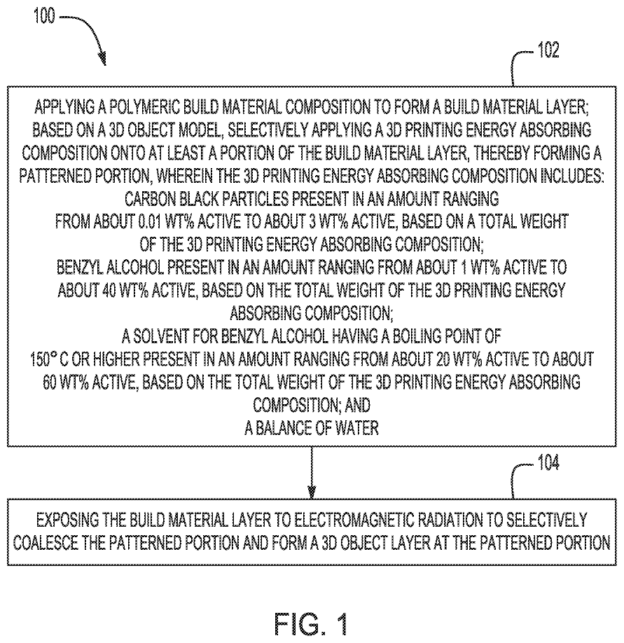

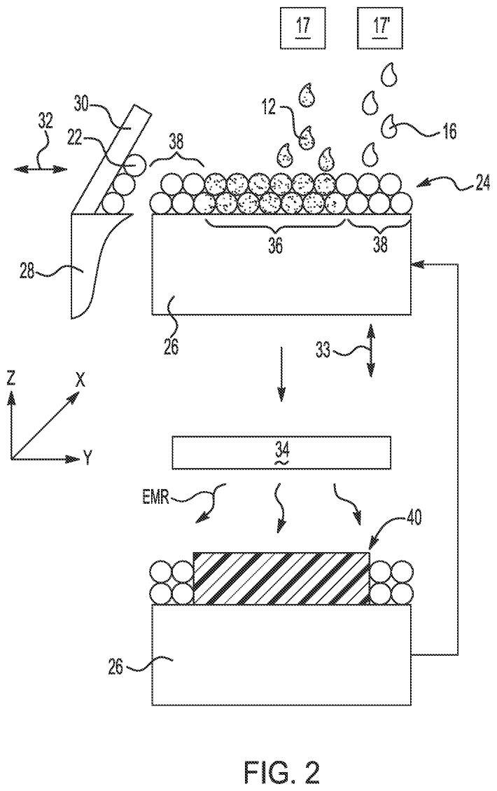

Different examples of the 3D printing method are shown and described in reference to FIG. 1 and FIG. 2.

Prior to execution of any examples of the method, it is to be understood that a controller may access data stored in a data store pertaining to a 3D part/object that is to be printed. For example, the controller may determine the number of layers of a build material composition that are to be formed, the locations at which the 3D printing energy absorbing composition is to be deposited on each of the respective layers, etc.

Referring now to FIG. 1, a flow diagram is depicted, illustrating an example 3D printing method 100 which utilizes the 3D printing energy absorbing composition, in accordance with the present disclosure.

The method 100 shown in FIG. 1 includes applying a build material composition to form a build material layer; based on a 3D object model, selectively applying a 3D printing energy absorbing composition onto at least a portion of the build material layer, thereby forming a patterned portion, wherein the 3D printing energy absorbing composition includes: carbon black particles present in an amount ranging from about 0.01 wt % active to about 3 wt % active, based on a total weight of the 3D printing energy absorbing composition; benzyl alcohol present in an amount ranging from about 1 wt % active to about 40 wt % active, based on the total weight of the 3D printing energy absorbing composition; a solvent for benzyl alcohol having a boiling point of 150° C. or higher present in an amount ranging from about 20 wt % active to about 60 wt % active, based on the total weight of the 3D printing energy absorbing composition; and a balance of water (reference numeral 102); and exposing the build material layer to electromagnetic radiation to selectively coalesce the patterned portion and form a 3D object layer at the patterned portion (reference numeral 104).

Any example of the 3D printing energy absorbing composition disclosed herein may be used in the method 100.

An example of the method 100 is shown schematically in FIG. 2. In FIG. 2, a layer 24 of the build material composition 22 is applied on a build area platform 26. It is to be understood that any of the build materials described herein may be used in the method 100. A printing system may be used to apply the build material composition 22. The printing system may include the build area platform 26, a build material supply 28 containing the build material composition 22, and a build material distributor 30.

The build area platform 26 receives the build material composition 22 from the build material supply 28. The build area platform 26 may be moved in the directions as denoted by the arrow 33, e.g., along the z-axis, so that the build material composition 22 may be delivered to the build area platform 26 or to a previously formed layer. In an example, when the build material composition 22 is to be delivered, the build area platform 26 may be programmed to advance (e.g., downward) enough so that the build material distributor 30 can push the build material composition 22 onto the build area platform 26 to form a substantially uniform layer 24 of the build material composition 22 thereon. The build area platform 26 may also be returned to its original position, for example, when a new part is to be built.

The build material supply 28 may be a container, bed, or other surface that is to position the build material composition 22 between the build material distributor 30 and the build area platform 26. The build material supply 28 may include heaters so that the build material composition 22 is heated to a supply temperature ranging from about 25° C. to about 150° C. In these examples, the supply temperature may depend, in part, on the build material composition 22 used and/or the 3D printer used. As such, the range provided is one example, and higher or lower temperatures may be used.

The build material distributor 30 may be moved in the directions as denoted by the arrow 32, e.g., along the y-axis, over the build material supply 28 and across the build area platform 26 to spread the layer 24 of the build material composition 22 over the build area platform 26. The build material distributor 30 may also be returned to a position adjacent to the build material supply 28 following the spreading of the build material composition 22. The build material distributor 30 may be a blade (e.g., a doctor blade), a roller, a combination of a roller and a blade, and/or any other device capable of spreading the build material composition 22 over the build area platform 26. For instance, the build material distributor 30 may be a counter-rotating roller. In some examples, the build material supply 28 or a portion of the build material supply 28 may translate along with the build material distributor 30 such that build material composition 22 is delivered continuously to the build area platform 26 rather than being supplied from a single location at the side of the printing system as depicted in FIG. 2.

The build material supply 28 may supply the build material composition 22 into a position so that it is ready to be spread onto the build area platform 26. The build material distributor 30 may spread the supplied build material composition 22 onto the build area platform 26. The controller (not shown) may process “control build material supply” data, and in response, control the build material supply 28 to appropriately position the particles of the build material composition 22, and may process “control spreader” data, and in response, control the build material distributor 30 to spread the build material composition 22 over the build area platform 26 to form the layer 24. In FIG. 2, one build material layer 24 has been formed.

The layer 24 has a substantially uniform thickness across the build area platform 26. In an example, the build material layer 24 has a thickness ranging from about 50 μm to about 120 μm. In another example, the thickness of the build material layer 24 ranges from about 30 μm to about 300 μm. It is to be understood that thinner or thicker layers may also be used. For example, the thickness of the build material layer 24 may range from about 20 μm to about 500 μm. The layer thickness may be about 2x (i.e., 2 times) the average diameter of the polymeric material at a minimum for finer part definition. In some examples, the layer thickness may be about 1.2x the average diameter of the polymeric material in the build material composition 22.

After the build material composition 22 has been applied, and prior to further processing, the build material layer 24 may be exposed to heating. In an example, the heating temperature may be below the melting point or melting range of the polymeric material in the build material composition 22. As examples, the pre-heating temperature may range from about 5° C. to about 50° C. below the melting point or the lowest temperature of the melting range of the polymeric material. In an example, the pre-heating temperature ranges from about 50° C. to about 205° C. In still another example, the pre-heating temperature ranges from about 100° C. to about 190° C. It is to be understood that the pre-heating temperature may depend, in part, on the build material composition 22 used. As such, the ranges provided are some examples, and higher or lower temperatures may be used.

Pre-heating the layer 24 may be accomplished by using any suitable heat source that exposes all of the build material composition 22 in the layer 24 to the heat. Examples of the heat source include a thermal heat source (e.g., a heater (not shown) integrated into the build area platform 26 (which may include sidewalls)) or a radiation source 34.

After the layer 24 is formed, and in some instances is pre-heated, the 3D printing energy absorbing composition 12 is selectively applied on at least some of the build material composition 22 in the layer 24 to form a patterned portion 36.

The amount of the 3D printing energy absorbing composition 12 that is applied per unit of the build material composition 22 in the patterned portion 36 may be sufficient to absorb and convert enough electromagnetic radiation so that the build material composition 22 in the patterned portion 36 will coalesce/fuse. The amount of the 3D printing energy absorbing composition 12 that is applied per unit of the build material composition 22 may depend, at least in part, on the carbon black particle loading in the 3D printing energy absorbing composition 12, and the polymeric material in the build material composition 22. In particular, the concentration of the carbon black particles in the energy absorbing composition 12 can be considered. This concentration can be used to determine how much energy absorbing composition 12 to apply to achieve a weight ratio of energy absorbing composition 12 to build material composition 22 for acceptable layer-by-layer fusing. Thus, if applying the energy absorbing composition 12 (10 wt %) to the build material composition 22 (90 wt %) at about a 1:9 weight ratio, then the carbon black particles to build material composition 22 weight ratio (as applied) can be from about 1:9000 to about 1:30. If more (up to 20 wt %) or less (down to 5 wt %) of the energy absorbing composition 12 is applied to the build material composition 22, then these ratios can be adjusted accordingly. That stated, the weight ratio of the carbon black particles to the build material composition 22 (as applied) in some more specific examples can be from about 1:1000 to about 1:80, from about 1:800 to about 1:100, or from about 1:500 to about 1:150, for example.

The energy absorbing composition 12 may be dispensed from an applicator 17. The applicator 17 may include a thermal inkjet printhead, a piezoelectric printhead, a continuous inkjet printhead, etc., and the selective application of the energy absorbing composition 12 may be accomplished by thermal inkjet printing, piezo electric inkjet printing, continuous inkjet printing, etc. The controller may process data, and in response, control the applicator 17 to deposit the energy absorbing composition 12 onto pre-determined portion(s) of the build material composition 22 to generate the patterned portion 36.

In some examples, the method 100 further comprises selectively applying, based on the 3D object model, a detailing agent 16 onto another portion of the build material layer 24 outside of the patterned portion 36 (e.g., at an unpatterned portion 38 as shown in FIG. 2).

As shown in FIG. 2, the detailing agent 16 may be selectively applied to the portion(s) 38 of the layer 24. The portion(s) 38 are not patterned with the 3D printing energy absorbing composition 12 and thus are not to become part of a final 3D object layer 40. Thermal energy generated during radiation exposure may propagate into the surrounding portion(s) 38 that do not have the 3D printing energy absorbing composition 12 applied thereto. The propagation of thermal energy may be inhibited, and thus the coalescence of the non-patterned build material portion(s) 38 may be prevented, when the detailing agent 16 is applied to these portion(s) 38.

In some other examples (not shown in FIG. 2), the detailing agent 16 may also or alternatively be applied to the patterned portion 36 or a portion of the patterned portion 36. The detailing agent 16 may be applied to the patterned portion 36 to provide a cooling effect so that the build material does not overheat and/or to lower the extent of fusing in the area patterned with both the energy absorbing composition 12 and the detailing agent 16. In these examples, the amount of the detailing agent 16 that is applied should be low enough so that fusing is not completely inhibited. In other examples, the detailing agent 16 and the energy absorbing composition 12 may intermingle at the edge(s) between the patterned portion 36 and the portion(s) 38.

The detailing agent 16 may be dispensed from an applicator 17′. The applicator 17′ may include a thermal inkjet printhead, a piezoelectric printhead, a continuous inkjet printhead, etc., and the selective application of the detailing agent 16 may be accomplished by thermal inkjet printing, piezo electric inkjet printing, continuous inkjet printing, etc. The controller may process data, and in response, control the applicator 17′ to deposit the detailing agent 16 onto pre-determined portion(s) of the build material composition 22 to generate the portion(s) 38.

It is to be understood that the selective application of any of the energy absorbing composition 12 and/or the detailing agent 16 may be accomplished in a single printing pass or in multiple printing passes. In some examples, the agent(s) is/are selectively applied in a single printing pass. In some other examples, the agent(s) is/are selectively applied in multiple printing passes. In one of these examples, the number of printing passes ranges from 2 to 4. It may be desirable to apply the energy absorbing composition 12 and/or the detailing agent 16 in multiple printing passes to increase the amount, e.g., of the carbon black particles, etc. that is applied to the build material composition 22, to avoid liquid splashing, to avoid displacement of the build material composition 22, etc.

After the energy absorbing composition 12 and/or detailing agent 16 are selectively applied in the specific portion(s) 36, 38 of the layer 24, the entire layer 24 of the build material composition 22 is exposed to electromagnetic radiation (shown as EMR in FIG. 2).

The electromagnetic radiation is emitted from the radiation source 34. The length of time the electromagnetic radiation is applied for, or energy exposure time, may be dependent, for example, on one or more of: characteristics of the radiation source 34; characteristics of the build material composition 22; and/or characteristics of the 3D printing energy absorbing composition 12. In an example, a single point of the build material layer 24 is exposed to electromagnetic radiation for a period of time ranging from 0.01 second to 1 second.

It is to be understood that the electromagnetic radiation exposure may be accomplished in a single radiation event or in multiple radiation events. The term “event,” as used herein, refers to one period of exposure of electromagnetic radiation from the radiation source 34. In an example, a radiation event may occur as a pass of a moveable radiation source 34 over the build material layer 24 (similar to a printing pass). In an example, the exposing of the build material composition 22 is accomplished in multiple radiation events. In a specific example, the number of radiation events ranges from 1 to 8. In still another specific example, the exposure of the build material composition 22 to electromagnetic radiation may be accomplished in 3 radiation events. It may be desirable to expose the build material composition 22 to electromagnetic radiation in multiple radiation events to counteract a cooling effect that may be brought on by the amount of the 3D printing energy absorbing composition 12 or detailing agent 16 that is applied to the build material layer 24. Additionally, it may be desirable to expose the build material composition 22 to electromagnetic radiation in multiple radiation events to sufficiently elevate the temperature of the build material composition 22 in the portion(s) 36 without over heating the build material composition 22 in the non-patterned portion(s) 38.

The energy absorbing composition 12 enhances the absorption of the radiation, converts the absorbed radiation to thermal energy, and promotes the transfer of the thermal heat to the build material composition 22 in contact therewith. In an example, the energy absorbing composition 12 sufficiently elevates the temperature of the build material composition 22 in the portion 36 to a temperature above the melting point or within the melting range of the polymeric material, allowing coalescing/fusing (e.g., thermal merging, melting, binding, etc.) of the build material composition 22 to take place. The application of the electromagnetic radiation forms the 3D object layer 40.

In some examples, the electromagnetic radiation has a wavelength ranging from 400 nm to 780 nm, or from 400 nm to 2500 nm, or from 780 nm to 2500 nm, or from 780 nm to 4000 nm. Radiation having wavelengths within the provided ranges may be substantially absorbed (e.g., 80% or more of the applied radiation is absorbed) by the 3D printing energy absorbing composition 12 and may heat the build material composition 22 in contact therewith, and may not be substantially absorbed (e.g., 25% or less of the applied radiation is absorbed) by the non-patterned build material composition 22 in portion(s) 38.

After the 3D object layer 40 is formed, additional layer(s) may be formed thereon to create an example of the 3D object. To form the next layer, additional build material composition 22 may be applied on the layer 40. The energy absorbing composition 12 is then selectively applied on at least a portion of the additional build material composition 22, according to the 3D object model. The detailing agent 16 may be applied in any area of the additional build material composition 22 where coalescence is not desirable. After the energy absorbing composition 12 and/or detailing agent 16 is/are applied, the entire additional layer of the additional build material composition 22 is exposed to electromagnetic radiation in the manner described herein. The application of additional build material composition 22, the selective application of the 3D printing energy absorbing composition 12 or the detailing agent 16, and the electromagnetic radiation exposure may be repeated for a predetermined number of cycles to form the final 3D object in accordance with the 3D object model. As such, some examples of the method 100 include repeating the applying of the build material composition 22, the selectively applying of the 3D printing energy absorbing composition 12, and the exposing, to form a predetermined number of 3D object layers 40 and a 3D printed object.

The 3D objects generated using the energy absorbing composition 12 may appear white or exhibit the color of the build material composition 22, due to the low loading of the carbon black particles. Color may be added during 3D printing or after the 3D object is generated by using the separate coloring agent (not shown).

In one example, the method 100 further comprises selectively applying, based on the 3D object model, a coloring agent to the patterned portion 36. In this example, the coloring agent is applied to the build material composition 22 along with the energy absorbing composition 12. In this example, the colorant of the coloring agent becomes embedded throughout the coalesced/fused build material composition 22 of the 3D object layers. To introduce the color, it may be desirable to introduce the coloring agent to patterned portions 36 that define an edge boundary of the 3D object being formed.

In yet another example, the method 100 further comprises selectively applying, based on the 3D object model, a coloring agent to the 3D object layer 40 (after fusing takes place). In this example, the coloring agent is applied to the exterior surface of the 3D object layer 40.

In the examples disclosed herein, a 3D object may be printed in any orientation. For example, the 3D object can be printed from bottom to top, top to bottom, on its side, at an angle, or any other orientation. The orientation of the 3D object can also be formed in any orientation relative to the layering of the build material composition 22. For example, the 3D object can be formed in an inverted orientation or on its side relative to the layering of the build material composition 22. The orientation of the build within each layer 24 can be selected in advance or even by the user at the time of printing, for example.

### Printed Article

Examples of the method(s) described herein may be used to generate a three-dimensional (3D) printed article/part, including: coalesced polymeric build material; and from about 0.001 wt % to about 1 wt %, based on a total weight of the 3D printed article, of carbon black particles.

Even though the 3D printed articles contain the carbon black particles, the 3D printed article exhibits a color of the polymeric build material. By “exhibits a color,” it is meant that the 3D object being referred to closely resembles the color of the build material used to 3D print the object. For example, the L* value of a 3D printed part that exhibits the color of the build material is within 25 of the L* value of the build material.

In some examples, the 3D printed article further comprises benzyl alcohol. It is to be understood that at least some of the benzyl alcohol may be evaporated during the 3D printing process, but in some instances, residual amounts may remain in the 3D object. In an example, the amount of residual benzyl alcohol that remains in the printed part ranges from about 0.1 wt % to about 15 wt %.

It is to be understood that other components of the build material composition (e.g., whitener, etc.) and components of the energy absorbing composition that do not evaporate are also present in the 3D printed articles. The weight percentage of each component will depend on the amount in the build material composition and/or energy absorbing composition, the dimensions of the part, the amount of the energy absorbing composition applied, the evaporation rate (if any) of the components, and other like conditions or parameters.

### Fluid Kit

Further described herein are examples of a fluid kit for three-dimensional (3D) printing. The fluid kit includes: (i) a three-dimensional (3D) printing energy absorbing composition including: carbon black particles present in an amount ranging from about 0.01 wt % active to about 3 wt % active, based on a total weight of the 3D printing energy absorbing composition; benzyl alcohol present in an amount ranging from about 1 wt % active to about 40 wt % active, based on the total weight of the 3D printing energy absorbing composition; a solvent for benzyl alcohol having a boiling point of 150° C. or higher present in an amount ranging from about 20 wt % active to about 60 wt % active, based on the total weight of the 3D printing energy absorbing composition; and a balance of water; and (ii) a detailing agent including a surfactant; a co-solvent; and a balance of water.

In some examples of the fluid kit, the detailing agent further includes an additive selected from the group consisting of an anti-kogation agent, an antimicrobial agent, a chelating agent, and a combination thereof (each of which is described hereinabove).

In some examples of the fluid kit, the benzyl alcohol and the solvent are present in the 3D printing energy absorbing composition in a weight ratio ranging from about 1:6 to about 2:3

Examples of the fluid kit are suitable for printing on the polymeric build materials described herein.

### Example

A comparative 3D printing energy absorbing composition and an example 3D printing energy absorbing composition were each prepared. The comparative formulation did not include benzyl alcohol; and the example formulation included benzyl alcohol, a solvent for benzyl alcohol, a surfactant, a hydrazide antioxidant, and a balance of water.

The components of the comparative formulation and the example formulation are shown in Table 1. All of the components included in both formulations were 100 wt % active, except for i) 2-pyrrolidinone (which was 95 wt % active), ii) the carbon black dispersion used in the comparative composition (which was 12.8 wt % active), and iii) the carbon black dispersion used in the example composition (which was 15.01 wt % active). As such, all other wt % values provided in Table 1 represent the wt % active of each component that was present in each formulation, based on a total weight of the formulation:

TABLE 1

| | | Formulation ID | |
|---|---|---|---|
| | | Comparative | Example |
| | Specific | Composition | Composition |
| Ingredient Type | Component | (wt %) | (wt %) |
| Electromagnetic | Carbon black | 5 | 0 |
| Radiation Absorber | dispersion | | |
| | (12.8% active) | | |
| | Carbon black | 0 | 1 |
| | dispersion | | |
| | (15.01% active) | | |
| Benzyl alcohol | Benzyl alcohol | 0 | 14 |
| Co-solvent | 2-pyrrolidinone | 19 | 0 |
| | (2-P) (95% active) | | |
| | Triethylene glycol | 8 | 0 |
| | (3EG) | | |
| | 1-(2-hydroxyethyl)- | 0 | 45 |
| | 2-pyrrolidone | | |
| Surfactant | TEGO ® WET 510 | 0.75 | 0 |
| | TERGITOL 15-S-9 | 0 | 0.75 |
| Anti-Kogation | CRODAFOS ® O3A | 0.45 | 0 |
| Agent | | | |
| Antimicrobial Agent | ACTICIDE ® B20 | 0.18 | 0 |
| | ACTICIDE ® M20 | 0.14 | 0 |
| Chelating Agent | TRILON ® M | 0.08 | 0 |
| Stabilizer | Adipic acid | 0 | 0.95 |
| | dihydrazide | | |
| DI Water | DI Water | Balance | Balance |

The example formulation was printed using a thermal inkjet printer to determine the printability and decap performance. To test the printability and decap performance, a reference line of the example formulation was printed from a printhead that was not uncapped (i.e., was not exposed to air). Then, the printhead was left uncapped (i.e., exposed to air) for a predetermined amount of time (e.g., 9 seconds) before the example formulation was ejected again from the printhead. The print results indicated very good decap performance and nozzle health. Thus, the example 3D printing energy absorbing composition exhibited acceptable 2D printing or jetting performance.

The comparative formulation and the example formulation were then used in a 3D printing process to generate comparative and example 3D printed objects. Some of the comparative and example 3D printed objects were type V dogbones, and one of the example 3D printed objects had a looped shape as shown in FIG. 4 (discussed below).

The polymeric build material used to generate all of the 3D printed objects was polyamide-12. The polyamide-12 build material was spread out into thin layers having a thickness ranging from about 80 μm. The comparative composition and the example composition were inkjet printed, independently, on each build material layer. The 3D printing energy absorbing composition loading was 4 drops per pixel for the example 3D objects and 1 drop per pixel for the comparative 3D objects. Each patterned layer was exposed to IR radiation. This process of spreading, inkjet printing, and exposing was repeated 50 times for each object (e.g., for 50 patterned layers) to form each dogbone. Eight comparative 3D objects (i.e. dogbones) and eight example 3D objects (i.e., dogbones) were generated.

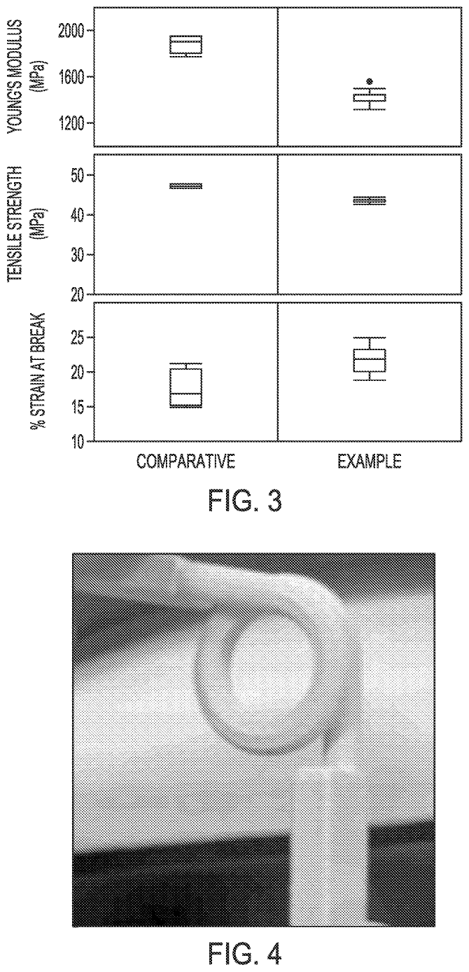

All of the dogbones were tested in order to determine the formulations' respective effects on the printed objects' properties in terms of Young's modulus (MPa), tensile strength (MPa), and % strain at break. The results of the testing are shown in FIG. 3 (in respective box-and-whisker plots for the eight example dogbones and the eight comparative dogbones). As can be seen in FIG. 3, the 3D printed dogbones generated using the example 3D printing energy absorbing composition displayed a higher average % strain at break and a lower average Young's modulus (meaning higher elasticity), relative to the comparative dogbones that were generated using the comparative 3D printing energy absorbing composition (which did not include any benzyl alcohol and included a higher loading of the carbon black particles). These results indicate a higher strength and flexibility for 3D printed dogbones generated using an example of the 3D printing energy absorbing composition described herein, relative to 3D printed dogbones generated using the comparative composition.

A photograph of the loop shaped 3D printed object generated using the example 3D printing energy absorbing composition was taken. A black and white reproduction of the photograph is shown in FIG. 4. The originally colored image of this black and white reproduction illustrated that the object produced using the 3D printing energy absorbing composition exhibited a color of the build material that was used to form the object (which in this example is off white). The visual results were confirmed with L* measurements.

L* measurements were taken for each of the 3D objects. The L* measurements were taken using an X-rite® eXact™ spectrophotometer. L* is a measure for lightness/whiteness ranging from black (L*=0) to white (L*=100). The L* value of the build material that was used to generate the 3D printed object was close to 100. The L* results are shown in Table 2. Table 2 depicts the location of the 3D object where the measurement was taken (top or bottom) and the L* value.

TABLE 2

| Metric | Top | Bottom |
|---|---|---|
| L* | 76.7 | 82.4 |

The L* values indicate that the carbon black particles in the example 3D printing energy absorbing composition did not introduce a darker color to 3D printed object. Visually, the 3D object had a color similar to that of the build material composition, and the L* values confirmed the visual observation. In comparison, 3D printed objects generated with the comparative composition have an L* value ranging from about 20 to about 60.

The results for the 3D object formed with the example 3D printing energy absorbing composition illustrate that the low loading of the carbon black particles enables sufficient absorption for creating a mechanically strong 3D printed object, and imparts little to no color of the carbon black particles to the 3D printed object such that the 3D printed object exhibits the color of the originally used build material composition.

It is to be understood that the ranges provided herein include the stated range and any value or sub-range within the stated range. For example, from about 0.01 wt % to about 3 wt % should be interpreted to include not only the explicitly recited limits of from about 0.01 wt % to about 3 wt %, but also to include individual values, such as about 0.25 wt %, about 0.55 wt %, about 1.74 wt %, about 2.03 wt %, about 2.9 wt %, etc., and sub-ranges, such as from about 0.2 wt % to about 2.8 wt %, from about 1 wt % to about 3 wt %, from about 0.5 wt % to about 2.5 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional (3D) printing energy absorbing composition, comprising:
carbon black particles present in an amount ranging from about 0.01 wt % active to about 3 wt % active, based on a total weight of the 3D printing energy absorbing composition;
benzyl alcohol present in an amount ranging from about 1 wt % active to about 40 wt % active, based on the total weight of the 3D printing energy absorbing composition;
a solvent for benzyl alcohol having a boiling point of 150° C. or higher present in an amount ranging from about 20 wt % active to about 60 wt % active, based on the total weight of the 3D printing energy absorbing composition; and
a balance of water.

2. The 3D printing energy absorbing composition as defined in claim 1 wherein the benzyl alcohol and the solvent are present in a weight ratio ranging from about 1:6 to about 2:3.

3. The 3D printing energy absorbing composition as defined in claim 1, further comprising a hydrazide antioxidant selected from the group consisting of adipic acid dihydrazide, oxalyl dihydrazide, succinic dihydrazide, azelaic dihydrazide, sebacic dihydrazide, dodecanedioic dihydrazide, and a combination thereof.

4. The 3D printing energy absorbing composition as defined in claim 3, wherein the hydrazide antioxidant is present in an amount ranging from about 0.01 wt % active to about 1 wt % active, based on the total weight of the 3D printing energy absorbing composition.

5. The 3D printing energy absorbing composition as defined in claim 1, wherein the solvent for benzyl alcohol is selected from the group consisting of 2-pyrrolidone, polyethylene glycol having a weight average molecular weight ranging from about 190 Daltons to about 420 Daltons, 1-(2-hydroxyethyl)-2-pyrrolidone, glycerol, propylene glycol, and combinations thereof.

6. The 3D printing energy absorbing composition as defined in claim 1, further comprising an additive selected from the group consisting of a humectant, a surfactant, an antimicrobial agent, a chelating agent, an anti-kogation agent, a pH adjuster, and combinations thereof.

7. A method for three-dimensional (3D) printing, comprising:
applying a polymeric build material composition to form a build material layer;
based on a 3D object model, selectively applying a 3D printing energy absorbing composition onto at least a portion of the build material layer, thereby forming a patterned portion, wherein the 3D printing energy absorbing composition includes:
carbon black particles present in an amount ranging from about 0.01 wt % active to about 3 wt % active, based on a total weight of the 3D printing energy absorbing composition;
benzyl alcohol present in an amount ranging from about 1 wt % active to about 40 wt % active, based on the total weight of the 3D printing energy absorbing composition;
a solvent for benzyl alcohol having a boiling point of 150° C. or higher present in an amount ranging from about 20 wt % active to about 60 wt % active, based on the total weight of the 3D printing energy absorbing composition; and
a balance of water; and
exposing the build material layer to electromagnetic radiation to selectively coalesce the patterned portion and form a 3D object layer at the patterned portion.

8. The method as defined in claim 7, further comprising selectively applying, based on the 3D object model, a detailing agent onto an other portion of the build material layer outside of the patterned portion.

9. The method as defined in claim 7, further comprising selectively applying, based on the 3D object model, a coloring agent to the patterned portion.

10. The method as defined in claim 7, further comprising selectively applying, based on the 3D object model, a coloring agent to the 3D object layer.

11. The method as defined in claim 7 wherein the benzyl alcohol and the solvent are present in the 3D printing energy absorbing composition at a weight ratio ranging from about 1:6 to about 2:3.

12. The method as defined in claim 7, wherein the 3D printing energy absorbing composition further comprises a hydrazide antioxidant selected from the group consisting of adipic acid dihydrazide, oxalyl dihydrazide, succinic dihydrazide, azelaic dihydrazide, sebacic dihydrazide, dodecanedioic dihydrazide, and a combination thereof.

13. A fluid kit for three-dimensional (3D) printing, comprising:
a three-dimensional (3D) printing energy absorbing composition including:
carbon black particles present in an amount ranging from about 0.01 wt % active to about 3 wt % active, based on a total weight of the 3D printing energy absorbing composition;
benzyl alcohol present in an amount ranging from about 1 wt % active to about 40 wt % active, based on the total weight of the 3D printing energy absorbing composition;
a solvent for benzyl alcohol having a boiling point of 150° C. or higher present in an amount ranging from about 20 wt % active to about 60 wt % active, based on the total weight of the 3D printing energy absorbing composition; and
a balance of water; and
a detailing agent including:
a surfactant;
a co-solvent; and
a balance of water.

14. The fluid kit as defined in claim 13, wherein the detailing agent further includes an additive selected from the group consisting of an anti-kogation agent, an antimicrobial agent, a chelating agent, and a combination thereof.

15. The fluid kit as defined in claim 13, wherein the benzyl alcohol and the solvent are present in the 3D printing energy absorbing composition in a weight ratio ranging from about 1:6 to about 2:3.
